(19) United States
(12) Patent Application Publication
(10) Pub. No.: US 2007/0171877 A1
(43) Pub. Date: Jul. 26, 2007

(54) Image processing apparatus and image processing system and its control method

(75) Inventors: Reiji Hasegawa, Kanagawa-ken (JP); Takeshi Suzuki, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/598,423

(22) PCT Filed: Mar. 29, 2005
(86) PCT No.: PCT/JP05/06569

§ 371 Date: Aug. 29, 2006

(30) Foreign Application Priority Data
Mar. 30, 2004 (JP) 2004-099731

(51) Int. Cl. H04Q 7/24

(52) U.S. Cl. 370/338

(57) ABSTRACT

An image processing apparatus connected with a wireless LAN unit having a USB host controller via a USB interface, which performs data transmission/reception to/from a PC included in a network with which the communication terminal is connected. A data-receiving request is issued to the wireless LAN unit via the USB interface, then, in correspondence with a data-request command sent from the wireless LAN unit in response to the data-receiving request, information related to the network, arranged by input from an operation unit, is transmitted to the wireless LAN unit. Communication with the PC is performed via the wireless LAN unit by using the information related to the network.

### TECHNICAL FIELD

The present invention relates to an image processing apparatus, connected to a communication terminal via a USB (Universal Serial Bus) interface, for communication with an information processing apparatus on a network including the communication terminal, an image processing system and its control method.

### BACKGROUND ART

In recent years, with advance in radio technology, a wireless network is popular and utilized in houses and offices, and there is a growing need for connection between a PC and a multi-function device having a printer function, a scanner function, a facsimile (FAX) function and the like, using such wireless network.

In a wireless network, various types of data are transmitted/received on the airwaves in packet form. Within the coverage area of the airwave, everyone in the network can receive the packet transmitted/received via the network. To secure the secrecy of the packet, the packet must be encrypted. As the encryption method, wep (Wire Equivalent Privacy) used in the IEEE 802.11b, the IEEE 802.11a and the like is known.

According to the encryption method, both devices in communication have the same encryption key. The transmitting-side device sends a packet encrypted by using the encryption key by wireless transmission, and the receiving side decrypts the received packet by using the encryption key. The encryption key may be dynamically changed in accordance with, e.g., the IEEE 802.11 μi , however, the basic method is not different as long as a psk (pre-shared key) is used.

In the case of connection between a PC and the above-described multi-function device via wireless communication, if the PC is already connected to the network and a user is to add a newly-purchased multi-function device to the network, as the PC and the multi-function device are connected by wireless communication, to perform safe wireless communication with secured secrecy, it is necessary to register the same encryption key in the PC and the multi-function device.

It is desirable to add a wireless communication function to the multi-function device, however, usually the wireless communication function is not implemented in the standard specification of multi-function device for the sake of cost reduction. Accordingly, for wireless communication, it is necessary to implement an optional wireless communication unit. In this case, as a common encryption key is registered in the multi-function device and the PC, and processing for this purpose is extremely complicated.

To avoid such troublesome work, as shown in FIG. 6, in conventional devices, a PC 200 and a wireless LAN unit 300 are directly interconnected via a cable by another interface 301 such as a USB interface. An encryption key is shared and wireless communication arrangement is performed between the PC 200 and the wireless LAN unit 300 via the USB interface 301. Thereafter, the USB interface 301 is removed, and wireless communication is started (See Japanese Patent Application Laid-Open No. 2002-236561).

However, in this method, the USB interface which is unnecessary in the wireless communication must be provided between the PC and the wireless LAN unit. Further, considering that the PC 200 and the wireless LAN unit 300 are to be installed in positions away from each other, and the introduction of wireless LAN is required for communication between remote positions, it is inconvenient to move any one of the PC 200 and the wireless LAN unit 300 to a position for the direct connection using the USB cable. Further, the wireless LAN unit 300 must be provided with a USB interface for connection with the PC 200 for arrangement of encryption key in addition to the USB interface for communication with the wireless LAN unit (multi-function device 1000 in FIG. 6), which is disadvantageous in point of cost.

### DISCLOSURE OF THE INVENTION

The present invention has been made in consideration of the above problems, and has its feature to address the above drawbacks of the above conventional art.

Further, the present invention has another feature to provide an image processing apparatus capable of data transmission/reception to/from an information processing apparatus included in a network via a communication terminal connected to the network, without adding excessive interface, an image processing system and its control method.

According to an aspect of the invention, there is provided with an image processing apparatus connected with a communication terminal having a USB host controller via a USB interface, for transmitting and receiving data to/from an information processing apparatus included in a network with which the communication terminal is connected, the apparatus comprising:

operation means, operated by a user, for inputting information to arrange information related to the network;

issuance means for issuing a data-receiving request to the communication terminal via the USB interface;

transmission means for transmitting the information related to the network, arranged by input using said operation means, to the communication terminal, in correspondence with a data-request command sent from the USB host controller in response to the data-receiving request; and

communication control means for communicating with the information processing apparatus via the communication terminal using the information related to the network.

According to another aspect of the invention, there is provided with a control method for an image processing apparatus connected with a communication terminal having a USB host controller via a USB interface, which performs data transmission/reception to/from an information processing apparatus included in a network with which the communication terminal is connected, the method comprising:

an input step of inputting information to arrange information related to the network operated by a user;

an issuance step of issuing a data-receiving request to the communication terminal via the USB interface;

a transmission step of transmitting the information related to the network, arranged by input in said input step, to the communication terminal, in correspondence with a data-request command sent from the USB host controller in response to the data-receiving request; and

a communication control step of communicating with the information processing apparatus via the communication terminal using the information related to the network.

Other features, objects and advantages of the present invention will be apparent from the following description when taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the configuration of an image processing system according to a first embodiment of the present invention;

FIG. 2 is a block diagram showing the schematic construction of a multi-function device according to the first embodiment;

FIG. 3 is a block diagram showing the schematic construction of a PC as an information processing terminal according to the first embodiment;

FIG. 4 is a block diagram showing the schematic construction of a wireless LAN unit according to the first embodiment;

FIG. 5A depicts an explanatory diagram showing conventional data transmission/reception between host side and device side in a USB interface;

FIG. 5B depicts an explanatory diagram showing the data transmission/reception according to the first embodiment;

FIG. 6 is a block diagram showing a method for performing communication arrangement in a conventional image processing system;

FIG. 7 is a flowchart showing processing for data transmission to a wireless LAN unit by the multi-function device according to the first embodiment;

FIG. 8 is a flowchart showing processing for data reception from the wireless LAN unit by the multi-function device according to the first embodiment;

FIG. 9 is a flowchart showing processing for transmission/reception to/from the multi-function device by the wireless LAN unit according to the first embodiment;

FIG. 10 is a block diagram showing the construction of the multi-function device according to a second embodiment of the present invention; and

FIG. 11 is a block diagram showing a USB function of the multi-function device according to the second embodiment.

### BEST MODE FOR CARRYING OUT THE INVENTION

Preferred embodiments of the present invention will now be described in detail in accordance with the accompanying drawings. Note that the following embodiments do not pose any Limitation on the invention described in the claims, but all the combinations of the features explained in the embodiments are not necessary for the solution by the invention.

### First Embodiment

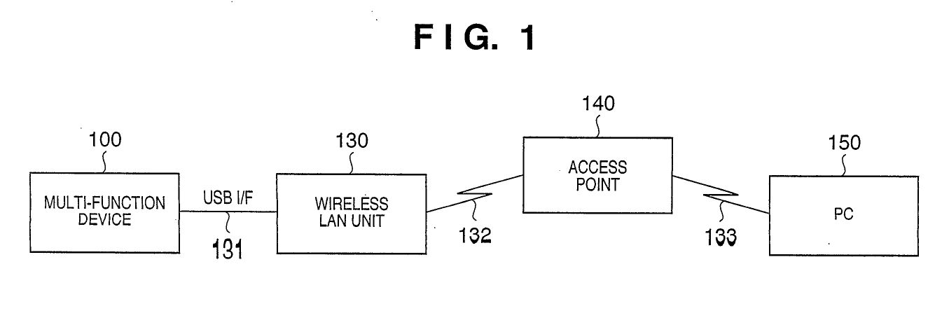

FIG. 1 is a block diagram showing the configuration of an image processing system according to a first embodiment of the present invention. Note that in the first embodiment, a multi-function device 100 having a printer function, a scanner function, a facsimile (FAX) function and the like will be described as an example of the image processing apparatus, however, the present invention is not limited to this device. The image processing apparatus may be a single-function apparatus such as a printer, a FAX apparatus or a scanner.

A wireless LAN unit 130, the details of which will be described later, is connected with the multi-function device (MFP) 100 via a USB interface 131. Further, the wireless LAN unit 130 is connected with an access point 140 via a local area network (LAN) 132. The LAN 132 may be a cable network or may be a wireless network. In FIG. 1, the LAN 132 is illustrated as a wireless network.

A PC 150, the details of which will be described later, is connected with the access point 140 via a local area network (LAN) 133. The LAN 133 may be a cable network or may be a wireless network. In FIG. 1, the LAN 133 is illustrated as a wireless network.

In the above construction, the multi-function device 100 is directly controlled from the PC 150 through the LANs 132 and 133 without USB interface. In this embodiment, a control protocol between the PC 150 and the multi-function device 100 is a well-known protocol.

The multi-function device 100 and the wireless LAN unit 130 are interconnected via the USB interface 131. The multi-function device 100 has a device (client) side USB interface, while the wireless LAN unit 130 has a host side USB interface. Though the details of the well-known USB communication will not be described, the USB host side takes the leading part, and the device side merely respond to a command.

In the first embodiment, arranged data for wireless network is inputted and sent to the PC 150 by the multi-function device 100, by defining a communication method for transmitting arranged data, inputted and set by using operation keys of the multi-function device 100, to the wireless LAN unit 130, by the multi-function device 100 as a main device of the communication.

In this arrangement, it is not necessary to move the multi-function device 100 or the PC 150 to a position where direct communication is possible for consistency of arranged data between the multi-function device 100 and the PC 150. Further, it is not necessary to newly provide input means for inputting arranged data, such as a display&console in the wireless LAN unit 130 which actually performs wireless communication.

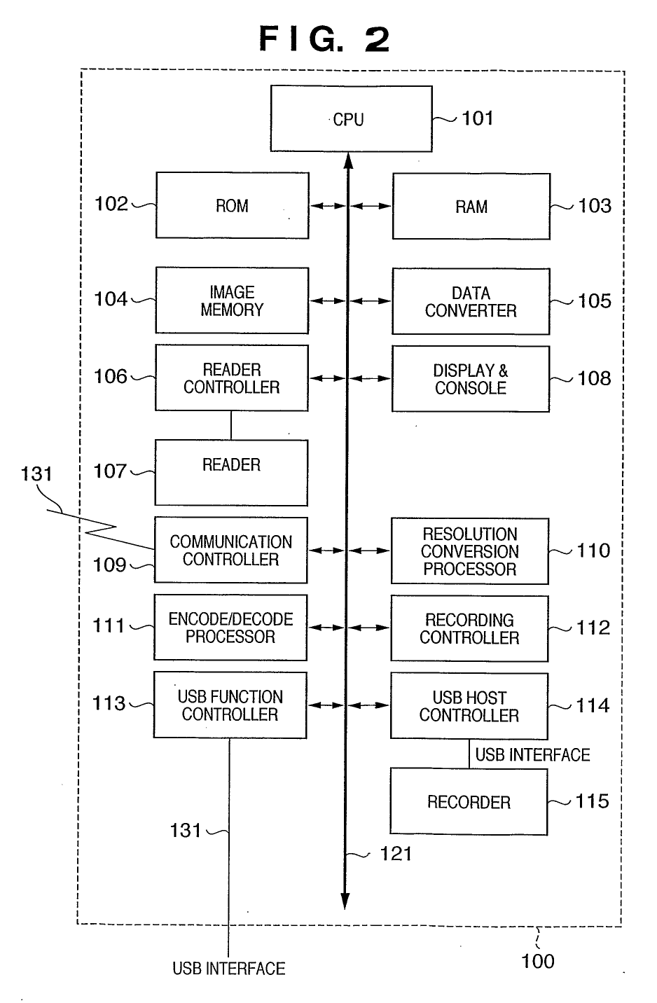

FIG. 2 is a block diagram showing the schematic construction of the multi-function device 100 according to the first embodiment.

In FIG. 2, a CPU 101 controls the entire operation of the multi-function device 100 in accordance with a control program stored in a ROM 102. The ROM 102 holds fixed data including the control program executed by the CPU 101, a data table, an installed operating system (OS) and programs. In the first embodiment, the respective control programs stored in the ROM 102 are used for execution of software such as scheduling, a task switch and interrupt processing under the management of the installed OS stored in the ROM 102. A RAM 103, having an SRAM (Static Random Access Memory) or the like with a back-up power source, holds data by a primary battery (not shown) for data back up, as a nonvolatile memory. Accordingly, the RAM 103 holds program control variables and the like which must not be deleted. Further, the RAM 103 has a memory area for storing set (arranged) values registered by an operator, management data for the multi-function device 10 and the like.

An image memory 104, having a DRAM (Dynamic Random Access Memory) or the like, holds image data. Further, a part of the area of the image memory 104 is ensured as a work area for execution of software processing. A data converter 105 performs image data conversion such as analysis of page description language (PDL) or the like and CG (Computer Graphics) drawing of characters. A reader controller 106 performs, via an image processing controller (not shown), various image processings such as binarization processing and halftone processing on an image signal, optically read from an original by a reader (scanner) 107 with a CIS (contact type of image sensor) and converted to electrical image data, and outputs processed signal as high definition image data. Note that the reader controller 106 and the reader 107 according to the first embodiment are applicable to a sheet reading control method of reading an original with a fixed CIS image sensor while conveying the original, and a book reading control method of scanning an original fixed on an original table with a moving CIS image sensor.

A display & console 108 includes an operation unit having numeral value input keys, character input keys, a mode setting key, a determination key, a cancel key and the like, various keys, an LED (Light Emission Diode), an LCD (Liquid Crystal Diode) and the like. The display & console 108 is used upon execution of the various functions as the multi-function device, and used upon network arrangement of the wireless LAN unit 130, input and editing of encryption key, display of operation status and device status of the multi-function device 100, and the like. A communication controller 109, having a modem (modulation and demodulation device), an NCU (Network Control Unit) and the like, enables FAX communication and data transmission/reception with a communication line 131. In the first embodiment, the communication controller 109 is connected with an analog communication line (PSTN) 131, and performs line control such as call origination and incoming call processing and the like on the communication line. A resolution converter 110 performs resolution control such as mutual conversion between millimeter-unit image data and inch-unit image data. Note that the resolution converter 110 also performs enlargement/reduction of image data. An encode/decode processor 111 performs coding/decoding processing or enlargement/reduction processing on image data (uncompressed, MH, MR, MMR, JBIG, JPG and the like) handled in the multi-function device 100.

A recording controller 112 performs various image processings such as smoothing processing, recording density correction processing and color correction processing on image data to be printed, via the image processing controller (not shown), thereby converts the image data to high definition image data, and outputs the data to a USB host controller 114 (to be described later). Further, the recording controller 112 assumes the role of obtaining status information of a recorder (printer) 115 periodically by controlling the USB host controller 114. A USB function controller 113 performs communication control by the USB interface 131. More specifically, the USB function controller 113 performs communication with the wireless LAN unit 130, performs protocol control in accordance with the USB communication standards, to convert data from a USB function control task executed by the CPU 101 into a packet and transmit the packet to the PC 150, or receive a USB packet from the PC 150 and convert the packet to data, and transmit the data to the CPU 101. The USB host controller 114 is a controller to perform communication using a protocol defined by the USB communication standards. The USB communication standards are defined for high-speed bidirectional communication. Plural hubs or functions (slaves) are connectable to one host (master). The USB host controller 114 functions as a host in USB communication.

The recorder 115 is a printer such as a laser-beam printer or an ink-jet printer controlled by a specialized CPU (not shown). The recorder 115 print-outputs color image data or monochrome image data received via a USB interface on a printing medium (print sheet). The recorder 115 and the USB host controller 114 perform communication using the protocol defined by the USB communication standards, and especially the recorder 115 has a function as a slave. In the first embodiment, the USB communication regarding a recording function is performed in one-to-one connection form. The above-described constituent elements 101 to 106, 108 to 114 and 116 are interconnected via a CPU bus 121 managed by the CPU 101.

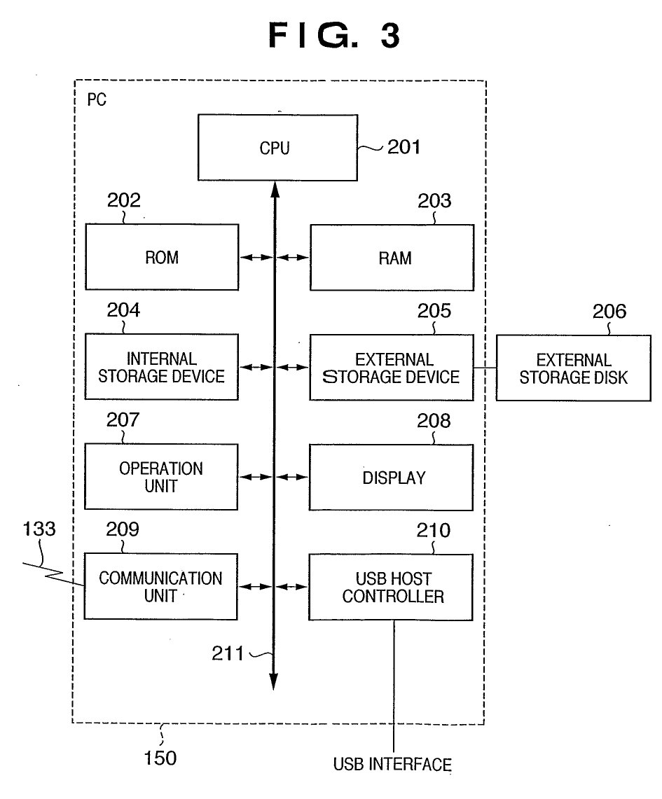

FIG. 3 is a block diagram showing the schematic construction of the PC 150 as an information processing terminal according to the first embodiment.

A CPU 201 controls the entire operation of the PC 150 via a system bus 211, in accordance with a program loaded into a RAM 203 via an internal storage device 204 or an external storage device 205 from an external storage disk 206. A ROM 202 holds the control program for the CPU 201 and the like. The RAM 203 holds the program read from the internal storage device 204 or the external storage device 205 for execution of the program by the CPU 201. Upon operation of the CPU 201, the RAM 203 provides a work area for storing image data and various data. The internal storage device 204 holds an operating system, various application programs, image data and the like. Application software for transmission/reception of various control commands and data to/from the multi-function device 100 including character data processing process according to the present embodiment, printer driver software, scanner driver software, facsimile driver software, USB class driver software for each of various functions, and USB bus driver software, and the like, are installed in the internal storage device 204. Generally, these application software and driver software are installed in the internal storage device 204 by receiving data from another computer-readable memory or an external storage disk 206 (floppy (registered trademark) disk, CD-ROM medium), and controlling the external storage device 205. Further, it may be arranged such that the application software and driver software are received by a communication unit 209 via the communication line 131 and installed in the internal storage device 204.

An operation unit 207 controls a keyboard and a mouse (not shown) as input means for inputting the operator's instruction. Generally, upon start of printing, the keyboard and mouse of the operation unit 207 are used. A display 208 produces various displays for the operator. When the execution of printing is started from the PC 150, a check dialog or the like is displayed on the display 208, asking the operator's input. Further, while the printing operation is performed, the display 208 provides information indicating the printing status to the operator. The communication unit 209, for communication with the wireless LAN 133 on the PC 150 side, performs data transmission/reception to/from the wireless LAN unit 130 and the multi-function device 100 via the access point 140. The USB host controller 210, which performs USB-interface communication control, converts data from the CPU 201 to a USB packet and transmits the USB packet to the multi-function device 100, or converts a USB packet from the multi-function device 100 to data and transmits the data to the CPU 201, in accordance with the USB communication standards. As the communication control method, a well-known method is used, and the explanation thereof will be omitted here.

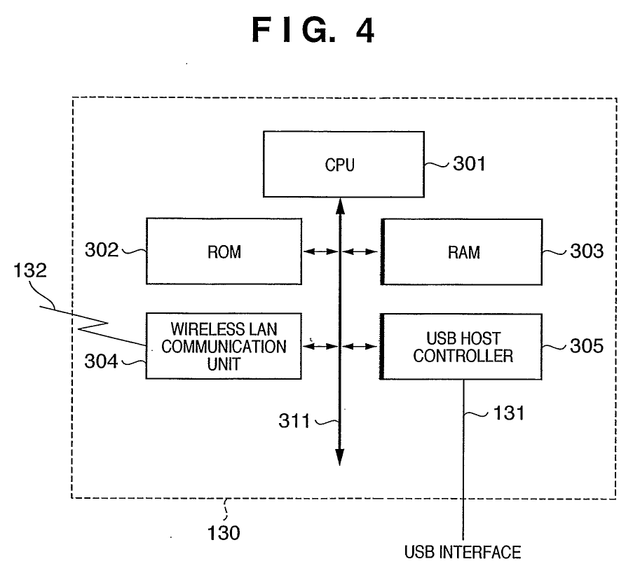

FIG. 4 is a block diagram showing the schematic construction of the wireless LAN unit 130 according to the first embodiment.

A CPU 301 controls the entire operation of the wireless LAN unit 130, in accordance with a program stored in a ROM 302 or a RAM 303, via a system bus 311. The ROM 302 holds the control program for the CPU 301 and the like. The RAM 303 temporarily holds programs and image data and the like. A wireless LAN communication unit 304 performs communication by the wireless LAN 132. The wireless LAN communication unit 304 may be constructed with a wireless LAN control chip (LSI) provided by various manufacturers, or further, to omit communication authentication, may be a PCMCIA card-type wireless LAN adapter connected with the system bus 311 through a PCMCIA card controller (not shown).

A USB host controller 305, which performs USB-interface communication control, converts data from the CPU 301 to a USB packet and transmits the USB packet to the multi-function device 100, or converts a USB packet from the multi-function device 100 to data and transmits the data to the CPU 301, in accordance with the USB communication standards. As the communication control method, a well-known method is used, and the explanation thereof will be omitted here.

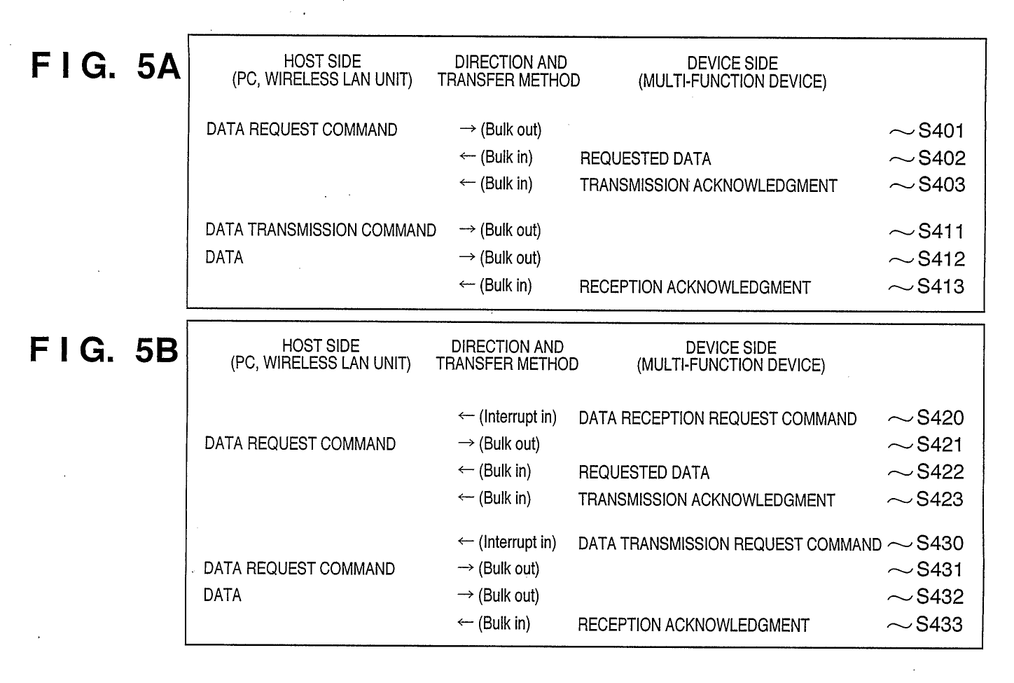

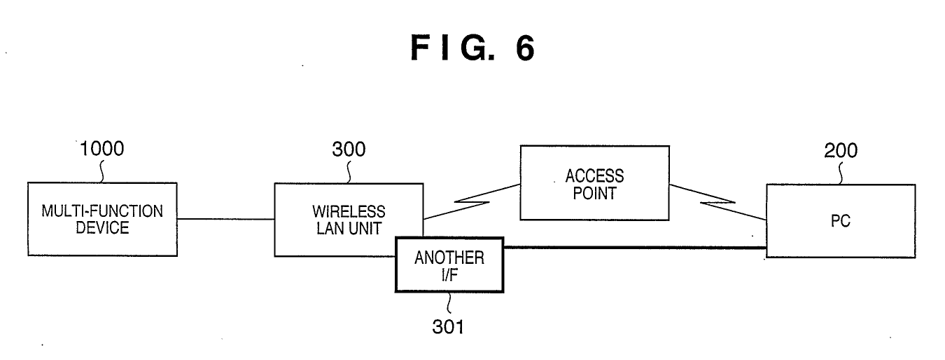

Prior to the explanation of a communication procedure between the multi-function device 100 and the wireless LAN unit 130 according to the first embodiment, a conventional communication procedure will be described with reference to FIG. 5A. Note that in FIGS. 5A and 5B, as the user operates the multi-function device 100, a leftward arrow from the device (multi-function device) to the host indicates “transmission”, while a rightward arrow from the host to the device (multi-function device) indicates “reception” in the figures. However, since the host (PC and wireless LAN unit) side is a main in the USB communication, the rightward arrow indicates transmission represented as “out”, while the leftward arrow indicates reception represented as “in”.

In FIG. 5A, when an inquiry about the encryption key inputted by the user is made from the wireless LAN unit to the multi-function device, the wireless LAN unit issues a data request command by “Bulk out” to the multi-function device (S401). In response to the command, the multi-function device returns the encryption key data by “Bulk in” (S402). Thereafter, the multi-function device returns an acknowledgment, indicating that the 1 set of command processing has been normally completed, to the host (wireless LAN unit) side (S403).

In this manner, in the conventional procedure, as the wireless LAN unit controls the communication as a main unit, even if an encryption key has been set in the multi-function device, it cannot be transmitted to the wireless LAN unit.

On the other hand, in the first embodiment as shown in FIG. 5B, when the user has inputted an encryption key in the multi-function device 100, to send the encryption key to the wireless LAN unit 130, a data reception request command is transmitted by “Interrupt in” (S420). Then the wireless LAN unit 130 issues a data request command by “Bulk out” (S421). In response to the command, the multi-function device 100 returns the encryption key by “Bulk in” (S422). Thereafter, the multi-function device 100 returns an acknowledgment, indicating that the 1 set of command processing has been normally completed, to the host (wireless LAN unit 130) (S423).

Next, an example of communication in the opposite direction, i.e., data transfer from the wireless LAN unit 130 to the multi-function device 100 will be described. In the conventional art in FIG. 5A, when the wireless LAN unit is to send network status data to the multi-function device, the host (wireless LAN unit) transmits a data transmission request command to the multi-function device by “Bulk out” (S411). Then the host sends the network status data to the multi-function device by “Bulk out” (S412). When the data has been normally received, the multi-function device returns an acknowledgment, indicating that the 1 set of command processing has been normally completed, by “Bulk in” (S413).

In this manner, in the conventional procedure, as the wireless LAN unit controls the communication as a main unit, even if the status of the wireless network is required in the multi-function device, the multi-function device cannot transmits a request for acquisition of the status to the wireless LAN unit.

On the other hand, in the first embodiment as shown in FIG. 5B, when the user desires to send an inquiry about the network status from the display&console 108 of the multi-function device 100 to the wireless LAN unit 130, the multi-function device 100 sends a host-to-device (out) direction data transmission request command, to the host by “Interrupt in” (S430). In response to the data transmission request command, the host 130 transmits a data request command to the multi-function device 100 by “Bulk out” (S431). Then the host 130 transmits the data indicating the network status to the multi-function device 100 by “Bulk out” (S432). When the data has been normally received, the multi-function device 100 returns a reception acknowledgment, indicating that the 1 set of command processing has been normally completed, to the lost by “Bulk in” (S433).

In this embodiment, as arrangement necessary for network connection as a wireless LAN, the encryption key and the network status are transmitted/received at steps S422 and S412. Further, information on currently-receivable plural access points and access point SSID, the IP address, subnet mask, default gateway, DNS server address and the like set in the wireless LAN unit, as well as the encryption key, can also be transmitted/received.

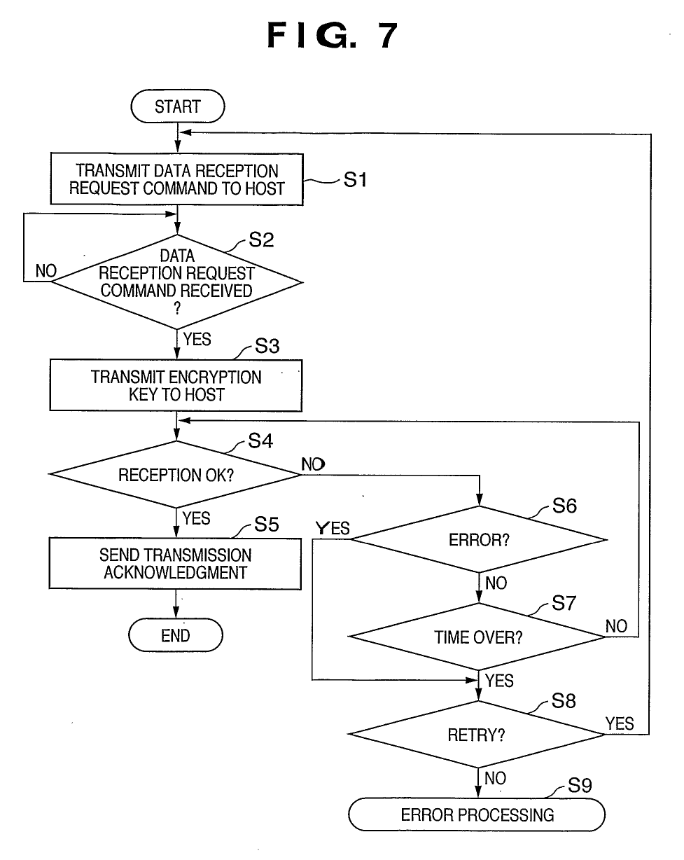

FIG. 7 is a flowchart showing processing for data transmission to the wireless LAN unit 130 by the multi-function device 100 according to the first embodiment. A program for execution of this processing is stored in the ROM 102 or the RAM 103, and is executed under the control of the CPU 101.

This processing is started when, e.g., an encryption key has been inputted by using the display & console 108, and the display & console 108 is operated for transmission of the encryption key to the wireless LAN unit 130. First, at step S1, a data reception request command is transmitted to the wireless LAN unit 130 via the USB interface 113 (S420 in FIG. 5B). Then at step S2, reception of a data request command, sent from the wireless LAN unit 130 in response to the command, is waited. When the command has been received (S421 in FIG. 5B), the process proceeds to step S3, at which the encryption key arranged in the multi-function device 100 is transmitted to the wireless LAN unit 130 (S422 in FIG. 5B). Note that the data handled in this communication is not limited to the encryption key but network arrangement information such as plural access point information and access point SSID, ID address, subnet mask, default gateway, DNS server address and the like arranged in the wireless LAN unit, may be handled. When it is determined at step S4 that the reception has been normally completed, the process proceeds to step S5, at which a transmission acknowledgment is transmitted to the wireless LAN unit 130 (S423 in FIG. 5B), and the process ends.

On the other hand, if it is determined at step S4 that the reception has not been normally completed, the process proceeds to step S6, at which it is examined whether or not error information has been received. If error information has been received, the process proceeds to step S8, while if error information has not been received, the process proceeds to step S7, at which it is examined whether or not response waiting time is over. If the response waiting time is not over, the process proceeds to step S4. If it is determined that the response waiting time is over, the process proceeds to step S8, at which it is determined whether or not retry is to be performed. If retry is to be performed, the process returns to step S1, to perform the above processing. If it is determined at step S8 that retry is not to be performed, the process proceeds to step S9, to perform error processing.

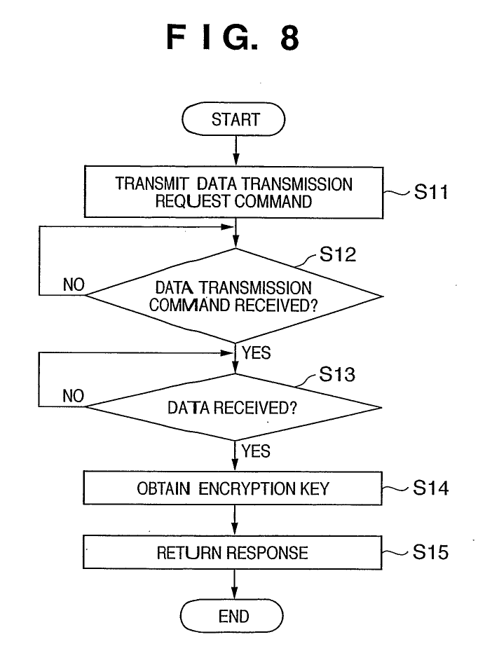

FIG. 8 is a flowchart showing processing for data reception from the wireless LAN unit 130 by the multi-function device 100 according to the first embodiment. A program for execution of this processing is stored in the ROM 102 or the RAM 103, and is executed under the control of the CPU 101. This processing is started when, e.g., reception of network information such as an encryption key in which the wireless LAN unit 130 has, is instructed by using the display & console 108.

First, at step S11, a data transmission request command is transmitted to the wireless LAN unit 130 (S430 in FIG. 5B). Next, at step S12, reception of data request command sent from the wireless LAN unit 130 in response to the command sent in the step S11 is waited. When the data request command has been received at step S12 (S431 in FIG. 5B), the process proceeds to step S13, at which data transmitted from the wireless LAN unit 130 is waited and received (S432 in FIG. 5B). When the data has been received, the process proceeds to step S14, at which an encryption key, network information or the like is obtained based on the received data. Then at step S15, an acknowledgment of reception is returned to the wireless LAN unit 130 (S433 in FIG. 5B). The encryption key and network information indicate an encryption key and network information in which the multi function device 100 has set to the wireless LAN unit 130 in advance, or an encryption key and network information in which the wireless LAN unit 130 has obtained from the access point 140 via the wireless LAN 132 in advance.

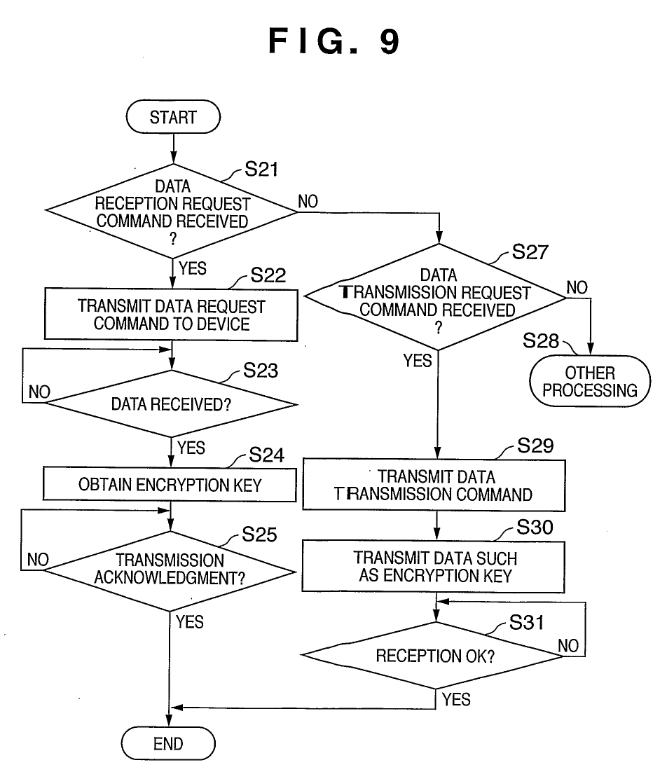

FIG. 9 is a flowchart showing processing for transmission/reception to/from the multi-function device 100 by the wireless LAN unit 130 according to the first embodiment. A program for execution of this processing is stored in the ROM 302, and is executed under the control of the CPU 301.

First, at step S21, it is determined whether or not the data reception request command (S420 in FIG. 5B) in the transmission processing at step S1 in FIG. 7 has been received. If it is determined that the data reception request command has been received, the process proceeds to step S22, at which a data request command is transmitted to the device (multi-function device 100) (S421 in FIG. 5B). Next, at step S23, data transmitted from the multi-function device 100 in response to the date request command is waited (S422 in FIG. 5B). When the data has been received, the process proceeds to step S24, at which an encryption key or the like arranged in the multi-function device 100 is obtained. Then at step S25, it is determined whether an acknowledgment of transmission has been received from the multi-function device 100 (S423 in FIG. 5B), if the acknowledgment is received, the process is terminated.

Further, if the data reception request command has not been received at step S21, the process proceeds to step S27, at which it is determined whether or not a data transmission request command (S430 in FIG. 5B) transmitted at step S11 in FIG. 8 has been received. If it is determined that the data transmission request command has been received, the process proceeds to step S29, at which a data request command, indicating that there is data to be transmitted from the wireless LAN unit 130, is transmitted to the multi-function device 100 (S430 in FIG. 5B). Next, at step S30, the information such as an encryption key in which the wireless LAN unit 130 has, is transmitted to the multi-function device 100 via the USB interface (S432 in FIG. 5B). Then at step S31, if it is determined by an acknowledgment of reception (S433 in FIG. 5B) from the multi-function device 100 that the data has been normally received, the process ends. Note that if it is determined at step S27 that the data transmission request command has not been received, the process proceeds to step S28, at which processing in correspondence with the received command is performed. However, as such processing is not related to the present invention, the explanation of the processing will be omitted.

Note that in the flowcharts of FIGS. 8 and 9, the error processing indicated at steps S6 to S9 in FIG. 7 is not described, however, the error processing is executed in a case where data from the wireless LAN unit 130 has not been normally received.

### Second Embodiment

Next, a second embodiment of the present invention will be described. In the second embodiment, the basic constructions and operations of the wireless LAN unit 130 and the PC 150 are the same as those in the first embodiment. The difference is that a multi-function device 100a has two USB interfaces. Accordingly, the difference from the first embodiment will be mainly described.

The multi-function device 100a according to the second embodiment is premised on connection with a host such as the PC 150 or the wireless LAN unit 130 via the USB. The multi-function device 100a is provided with an operation unit, and signal transmission to the host is made in the HID class of the USB. Further, the multi-function device 100a has a display unit to display character and image information from the host in, e.g., the vendor class. For this purpose, the multi-function device has at least two USB interfaces. The two interfaces have a compound structure. The user inputs various network arrangements and encryption key using the operation unit of the multi-function device 100a. The signal is directly transmitted via the USB to the wireless LAN unit. The input characters are displayed for the user on the display unit of the multi-function device 100a also through the USB.

As the schematic configuration of the image processing system according to the second embodiment is the same as that described in FIG. 1, the explanation of the configuration will be omitted.

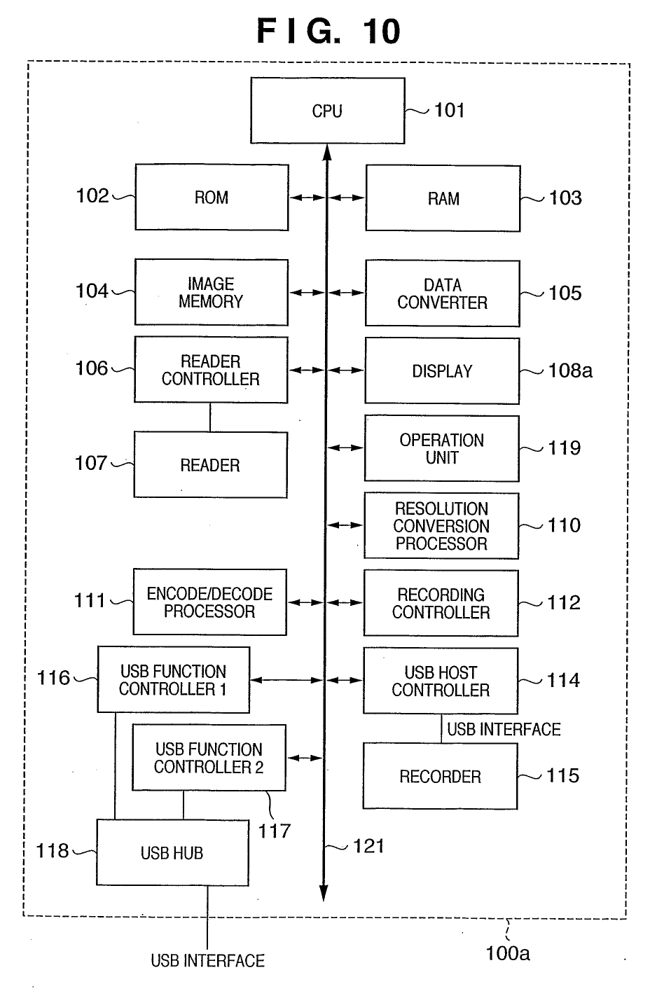

FIG. 10 is a block diagram showing the construction of the multi-function device 100a according to the second embodiment of the present invention. In FIG. 10, elements corresponding to those in FIG. 2 have the same reference numerals, and the explanations thereof will be omitted.

A display 108a, having an LED (light emission diode) and a LCD (liquid crystal display) and the like, displays display data sent from a USB function controller 1 (116). Further, the display 108a displays operation status, device status and the like of the multi-function device 100a as a single device. An operation unit 119, having a display&console with numeral value input key, character input keys, a mode setting key, a determination key, a cancel key and the like displayed on the display 108a and various keys, transmits key information instructed by the user to the PC 150 through a USB function controller 2 (117). In this embodiment, various functions as the multi-function device 100a, network arrangement in the wireless LAN unit 130, input and editing of encryption key can be performed by the operation unit 119.

The USB function controller 1 (116) and the USB function controller 2 (117), for USB interface communication control, perform protocol control in accordance with the USB communication standards. More particularly, the USB function controllers 1 and 2 convert data from a USB function control task executed by the CPU 101 into a packet and transmit the packet to the PC 150, or receive a USB packet from the PC 150, convert the packet to data and transmit the data to the CPU 101. A USB hub 118, which may be a general commercial USB hub, unites the two USB devices, i.e., the USB function controller 1 (116) and the USB function controller 2 (117).

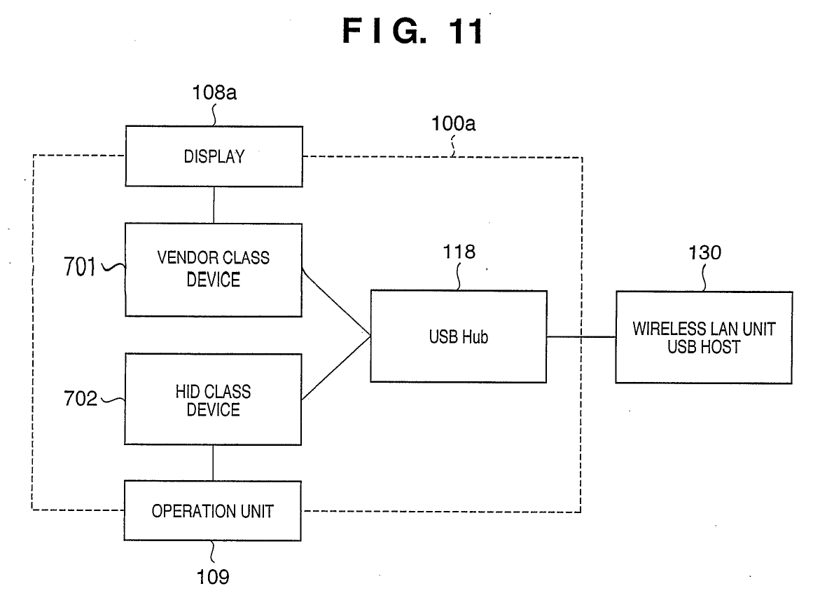

FIG. 11 is a block diagram showing the USB function of the multi-function device 100a according to the second embodiment.

The multi-function device 100a operates under the control of one CPU 101, however, the multi-function device is recognized from the PC 150 as an HID class USB device 702 including the operation unit 119 and the USB function controller 2 (117) on the USB. Similarly, the multi-function device is recognized as a vendor class USB device 701 including the entire multi-function device 100a, the display 108a and the USB function controller 1 (116). Further, the multi-function device 100a is recognized from the USB host controller 305 of the wireless LAN unit 130 as a pair of vendor class device 701 and HID class device 702 connected with the USB hub 118.

Note that the USB host controller 305 of the wireless LAN unit 130 (FIG. 4) according to the second embodiment performs USB interface communication control. The USB host controller 305 converts data from the CPU 301 to a USB packet and transmits the USB packet to the multi-function device 100a, or converts a USB packet from the multi-function device 100a to data and transmits the data to the CPU 301, in accordance with the USB communication standards. Generally, such small controller is not provided with an advanced USB host controller, however, in the second embodiment, a USB controller which controls at least two interfaces or two devices is employed. As the communication control method, a well-known method is used, and the explanation of the method will be omitted.

The object of the present invention can also be achieved by providing a storage medium holding software program code for performing the functions of the embodiments to a system or an apparatus, reading the program code with a computer (e.g., CPU, MPU) of the system or apparatus from the storage medium, then executing the program. In this case, the program code read from the storage medium realizes the functions according to the embodiments, and the storage medium holding the program code constitutes the invention. Further, the storage medium, such as a floppy disk, a hard disk, an optical disk, a magneto-optical disk, a CD-ROM, a CD-R, a DVD, a magnetic tape, a non-volatile type memory card, and ROM can be used for providing the program code.

Furthermore, besides aforesaid functions according to the above embodiments are realized by executing the program code which is read by a computer, the present invention includes a case where an OS (operating system) or the like working on the computer performs a part or entire actual processing in accordance with designations of the program code and realizes functions according to the above embodiments.

Furthermore, the present invention also includes a case where, after the program code read from the storage medium is written in a function expansion card which is inserted into the computer or in a memory provided in a function expansion unit which is connected to the computer, CPU or the like contained in the function expansion card or unit performs a part or entire process in accordance with designations of the program code and realizes functions of the above embodiments.

As described above, according to the embodiments, a multi-function device can be used in wireless LAN merely by adding slight changes and a wireless LAN unit.

Further, the arrangements in the wireless LAN unit and arrangements by the PC included in the wireless LAN unit can be changed to desired arrangements by using an operation unit of the multi-function device.

The present invention is not limited to the above embodiments and various changes and modifications can be made within the spirit and scope of the present invention. Therefore, to appraise the public of the scope of the present invention, the following claims are made.

### CLAIM OF PRIORITY

This application claims priority from Japanese Patent Application No. 2004-099731 filed on Mar. 30, 2004, the entire contents of which are hereby incorporated by reference herein.

1. An image processing apparatus connected with a communication terminal having a USB host controller via a USB interface having a USB function controller, for transmitting and receiving data to/from an information processing apparatus included in a network with which the communication terminal is connected, the apparatus comprising:
operation means, operated by a user, for inputting information to arrange information related to the network;
issuance means for issuing a data-receiving request to the communication terminal via the USB interface;
transmission means for transmitting the information related to the network, arranged by input using said operation means, to the communication terminal, in correspondence with a data-request command sent from the USB host controller in response to the data-receiving request; and
communication control means for communicating with the information processing apparatus via the communication terminal using the information related to the network.

2. The image processing apparatus according to claim 1, further comprising:
means for issuing a data request to the communication terminal via the USB interface; and
reception means for receiving the information related to the network sent from the USB host controller in response to the data request.

3. The image processing apparatus according to claim 1, wherein the network is a wireless network, and the information related to the network includes an encryption key in the image processing apparatus and the information processing apparatus.

4. An image processing system comprising:
a wireless communication unit having a wireless communicator and a USB host controller, configured to execute data transmission/reception to/from an information processing apparatus via a wireless communication channel;
an image processing unit having a console and a USB function controller and connected with said wireless communication unit via a USB interface, configured to arrange a value for communication by said wireless communication unit via the wireless communication channel; and
transfer means for transferring the value, arranged using the console, from said image processing unit to said wireless communication unit,
wherein data transfer is enabled between the information processing apparatus and said image processing unit based on the value transferred by said transfer means.

5. The image processing system according to claim 4, wherein said wireless communication unit requests said value from said image processing unit in correspondence with a data-receiving request command received from said image processing unit via said USB interface.

6. The image processing system according to claim 4, wherein said wireless communication unit transmits the value to said image processing unit in correspondence with a data-request command received from said image processing unit via the USB interface.

7. The image processing system according to claim 4, wherein the value includes an encryption key to perform wireless communication via said wireless communication unit.

8. The image processing system according to claim 4, wherein said image processing unit further has a USB hub connected with said wireless communication unit,
and wherein the console is connected with a first USB function controller, and the value is arranged for said wireless communication unit from the console through the first USB interface.

9. The image processing system according to claim 4, wherein said image processing unit further has a display unit and a second USB function controller,
and wherein the display unit displays a value inputted from the console via the second USB function controller.

10. A control method for an image processing apparatus connected with a communication terminal having a USB host controller via a USB interface having a USB function controller, which performs data transmission/reception to/from an information processing apparatus included in a network with which the communication terminal is connected, the method comprising:
an input step of inputting information to arrange information related to the network operated by a user;
an issuance step of issuing a data-receiving request to the communication terminal via the USB interface;
a transmission step of transmitting the information related to the network, arranged by input in said input step, to the communication terminal, in correspondence with a data-request command sent from the USB host controller in response to the data-receiving request; and
a communication control step of communicating with the information processing apparatus via the communication terminal using the information related to the network.

11. The control method according to claim 10, further comprising:
a step of issuing a data request to the communication terminal via the USB interface; and
a reception step of receiving the information related to the network sent from the USB host controller in response to the data request.

12. The control method according to claim 10, wherein the network is a wireless network, and the information related to the network includes an encryption key in the image processing apparatus and the information processing apparatus.

13. A control method for an image processing system having: a wireless communication unit having a wireless communicator to execute data transmission/reception to/from an information processing apparatus via a wireless communication channel and a USB host controller; and an image processing unit, having a console to arrange a value for communication by the wireless communication unit via the wireless communication channel and a USB function controller, connected with the wireless communication unit via a USB interface, said method comprising:
a transfer step of transferring the value, arranged using the console, from the image processing unit to the wireless communication unit,
wherein data transfer is enabled between the information processing apparatus and the image processing unit based on the value transferred in said transfer step.

14. The control method according to claim 13, wherein the wireless communication unit requests the value from the image processing unit in correspondence with a data-receiving request command received from the image processing unit via the USB interface.

15. The control method according to claim 13, wherein the wireless communication unit transmits the value to the image processing unit in correspondence with a data-request command received from the image processing unit via the USB interface.

16. The control method according to claim 13, wherein the value includes an encryption key to perform wireless communication via the wireless communication unit.

17. The control method according to claim 13, wherein the image processing unit further has a USB hub connected with the wireless communication unit,
and wherein the console is connected with a first USB function controller, and the value is arranged for the wireless communication unit from the console through the first USB interface.

18. The control method according to claim 13, wherein the image processing unit further has a display unit and a second USB function controller,
and wherein the display unit displays a value inputted from the console via the second USB function controller.
